(19) United States
(12) Patent Application Publication
(10) Pub. No.: US 2002/0056699 A1
(43) Pub. Date: May 16, 2002

(54) Method for eliminating surface roughness in metal lines

(75) Inventors: Chih-Chung Sun, Taoyuan Hsien (TW); Yao-Chung Chang, Taoyuan Hsien (TW)

Correspondence Address: DARBY & DARBY P.C., 805 Third Avenue, New York, NY, 10022, US

(73) Assignee: Hannstar Display Corp.

(21) Appl. No.: 09/939,328

(22) Filed: Aug. 24, 2001

(30) Foreign Application Priority Data
Nov. 10, 2000 (TW) 89123796

(51) Int. Cl. B44C 1/22

(52) U.S. Cl. 216/37; 216/38; 216/92

(57) ABSTRACT

A method of eliminating surface roughness of metal lines is disclosed, which can effectively improve the rough edges formed on the surface of the metal lines after wet etching during the manufacturing process of a thin film transistor, so that reliability is increased and current leakage can be avoided. The method includes the steps of: applying a tetra-methyl ammonium hydroxide solution to the rough surface of the metal lines and keeping the metal lines still for a predetermined time; and rinsing the metal lines to remove the tetra-methyl ammonium hydroxide solution left on the surface of the metal lines.

### BACKGROUND OF THE INVENTION

1. Field of the Invention

The present invention relates to a method for eliminating the surface roughness in metal lines, as caused by wet etching during the manufacturing process of thin film transistor arrays.

2. Description of the Related Art

Liquid crystal display (hereinafter referred to as LCD) is a flat display that is widely used. Since LCD is light and thin and has the advantages of low power consumption and low driving voltage, it has a variety of applications such as notebooks, digital cameras, video games and projectors.

Among various types of LCDs, thin film transistor (Hereinafter referred to as TFT) LCD is acknowledged to have better driving and switching abilities than other active matrix LCDs. However, in the conventional process of manufacturing TFT arrays, roughness occurs on the exposed surface of the metal lines after etching if a wet etching step i s adopted to etch the metal lines. Refer to FIG. 1, an SEM (Scanning Electron Microscope) image of the surface of the metal lines after etching. As shown in the image, a rough edge is formed on the exposed surface of the metal lines after etching, which includes many tiny and pointed extrusions as indicated by arrow A. The metal lines can be made of aluminum or aluminum alloy.

Since the rough edges of the metal lines are tiny and pointed, subsequent processes such as deposition will be affected, reducing reliability. Moreover, the rough edges may pierce the deposition layer formed in a later step, causing current leakage. Therefore, it is important to eliminate the roughness formed on the surface of the metal lines after etching, in order to increase the reliability of TFT fabrication and to prevent current leakage.

### SUMMARY OF THE INVENTION

Accordingly, an object of the present invention is to provide a method for eliminating roughness on the surface of the metal lines. This method can effectively smooth the rough surfaces of the metal lines caused by wet etching, increasing the reliability of the manufacturing process and avoiding current leakage of the TFT due to punctures of the deposition layer subsequently formed on the metal lines.

### BRIEF DESCRIPTION OF THE DRAWINGS

The present invention can be more fully understood by reading the subsequent detailed description in conjunction with the examples and references made to the accompanying drawings, wherein:

FIG. 1 is an SEM image illustrating the surface of the metal lines before processing by the method of this invention;

FIG. 2 is an SEM image illustrating the surface of the metal lines after processing by the method of this invention; and

FIG. 3 is a flowchart of the method of this invention.

### DETAILED DESCRIPTION OF THE PREFERRED EMBODIMENT

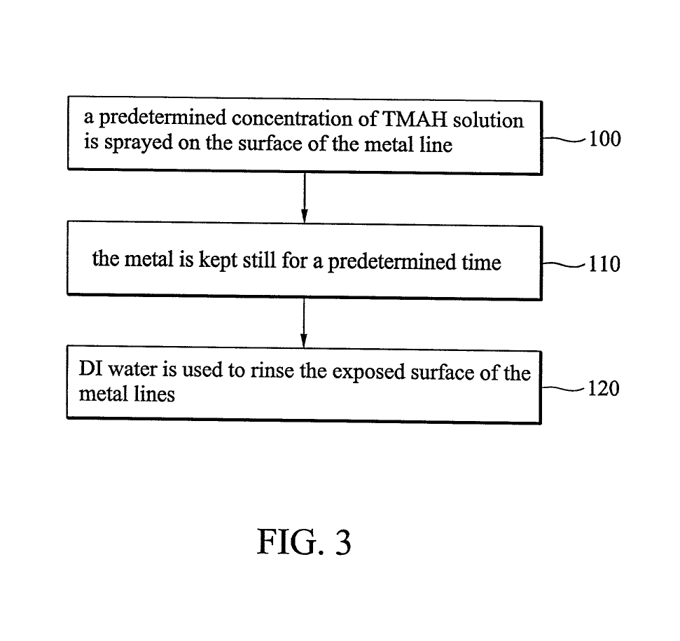

Refer to FIG. 3, according to. one preferred embodiment of this invention, the method for eliminating the surface roughness of the metal lines of a TFT array includes the following steps.

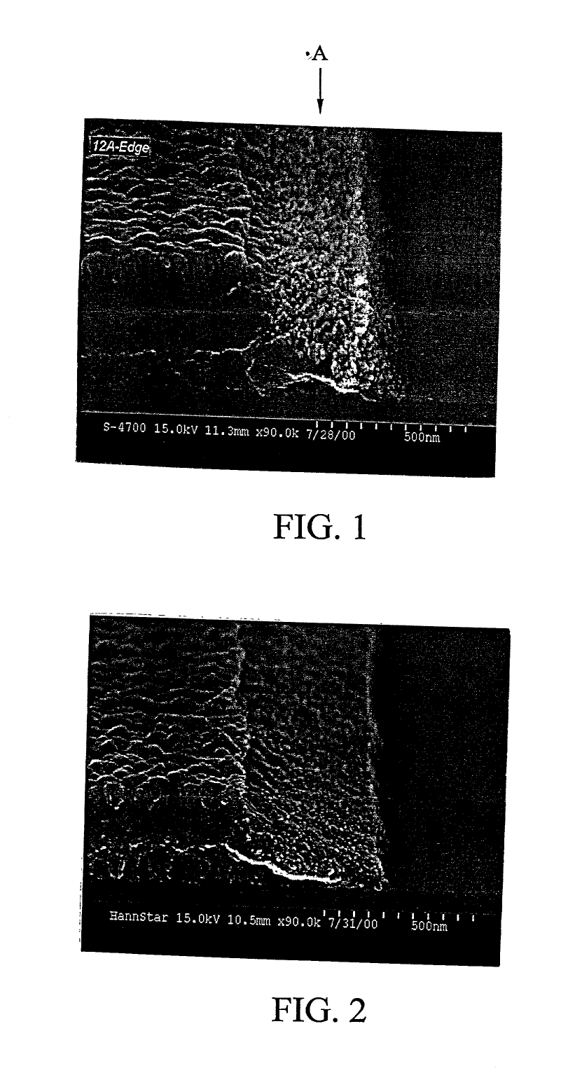

First, in step 100, a predetermined concentration of tetra-methyl ammonium hydroxide (hereinafter referred to as TMAH) solution is sprayed on the surface of the metal lines of FIG. 1. The concentration of the TMAH solution is less than 10 parts by weight, and is preferably less than 5 parts by weight, but can not be less than 1 part by weight. A 2.38 parts by weight of TMAH solution is used in this embodiment.

Second, in step 110, the metal is kept still for a predetermined time to ensure the TMAH solution is sufficiently reactive withthe metal. Next, in step 120, deionized (DI) water is used to rinse the exposed surface of the metal lines to remove remaining TMAH solution. The time to keep the metal still is preferably about 8 to 15 seconds. The metal lines sprayed with the TMAH solution are kept still for about 10 seconds in this embodiment.

Referring to FIG. 2, it is found that the rough edge formed on the exposed surface of the metal lines becomes smooth. In other words, the method of this invention can effectively improve the surface roughness of the metal lines. Thus the reliability of the subsequent process is increased, and current leakage due to the puncture of the deposition layer is avoided.

The method of this invention can be applied to, but not limited to, the manufacturing process of TFT. The surface roughness of a metal lines caused by wet etching during any semiconductor-related process can be improved by adopting the method of this invention.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of eliminating surface roughness of metal lines, which is suitable for use in a semiconductor manufacturing process, including the steps of:
applying a tetra-methyl ammonium hydroxide solution to the rough surface of the metal lines and keeping the metal lines still for a predetermined time; and
rinsing the metal lines.

2. The method as claimed in claim 1 wherein the tetra-methyl ammonium hydroxide solution is sprayed on the surface of the metal lines.

3. The method as claimed in claim 1 wherein tetra-methyl ammonium hydroxide solution has a concentration of about 1 to 10 parts by weight.

4. The method as claimed in claim 3 wherein the tetra-methyl ammonium hydroxide solution has a concentration of about 2.38 parts by weight.

5. The method as claimed in claim 1 wherein the metal lines is made of aluminum.

6. The method as claimed in claim 1 wherein the metal lines is made of aluminum alloy.

7. The method as claimed in claim 1 wherein the predetermined time is about 8 to 15 seconds.

8. A method of eliminating surface roughness of metal lines, which is suitable to use in a manufacturing process of a thin film transistor, including the steps of:
applying a tetra-methyl ammonium hydroxide solution having a concentration of about 1 to 10 parts by weight to the rough surface of the metal lines and keeping the metal lines still for a predetermined time; and
using deionized water to rinse the metal lines.

9. The method as claimed in claim 8 wherein the tetra-methyl ammonium hydroxide solution has a concentration of about 2.38 parts by weight.

10. The method as claimed in claim 8 wherein the predetermined time is about 8 to 15 seconds.

11. A method for forming metal lines in a TFT array comprising the steps of:
forming a metal layer on deposited layers formed in a manufacturing process of the TFT array;
wet-etching the metal layer to form metal lines;
applying a tetra-methyl ammonium hydroxide solution to rough surface of the metal lines and keeping the metal lines still for a predetermined time; and
rinsing the metal lines.

12. The method as claimed in claim 11 wherein the tetra-methyl ammonium hydroxide solution is sprayed on the surface of the metal lines.

13. The method as claimed in claim 11 wherein tetra-methyl ammonium hydroxide solution has a concentration of about 1 to 10 parts by weight.

14. The method as claimed in claim 13 wherein the tetra-methyl ammonium hydroxide solution has a concentration of about 2.38 parts by weight.

15. The method as claimed in claim 11 wherein the metal lines is made of aluminum.

16. The method as claimed in claim 11 wherein the metal lines is made of aluminum alloy.

17. The method as claimed in claim 11 wherein the predetermined time is about 8 to 15 seconds.
